(19) United States
(12) Patent Application Publication
(10) Pub. No.: US 2012/0304770 A1
(43) Pub. Date: Dec. 6, 2012

(54) DRIVING CONTROL MODULE AND METHOD FOR INERTIAL SENSOR

(75) Inventors: Kyung Rin Kim, Gyunggi-do (KR); Byoung Won Hwang, Gyunggi-do (KR); Jung Won Lee, Seoul (KR); Ho Seop Jeong, Gyunggi-do (KR)

(73) Assignee: SAMSUNG ELECTRO-MECHANICS CO., LTD., Gyunggi-do (KR)

(21) Appl. No.: 13/284,246

(22) Filed: Oct. 28, 2011

(30) Foreign Application Priority Data
Jun. 1, 2011 (KR) 1020110052812

(51) Int. Cl. G01P 15/08

(52) U.S. Cl. 73/514.35

(57) ABSTRACT

Disclosed herein is a driving control module for an inertial force. The driving control module includes a timing control unit that applies a driving signal and a sensing signal; a driving unit that receives the driving signal from the timing control unit and applies the driving signal to a sensor; a sensing unit that receives the sensing signal from the timing control unit, applies the sensing signal to a sensor, and senses stabilization driving and inertial force of the sensor; and a driving control unit that locks application of the driving signal from the timing control unit to the driving unit. As a result, the exemplary embodiment of the present invention can provide a driving control module and a method for an inertial sensor capable of obtaining a maximum sampling rate by sensing the stabilization driving of the driving unit and locking and sensing the application of the driving signal from the timing control unit at the time of the stabilization driving and capable of performing an efficient control by reducing the additional driving for stable sensing and the sensing loss.

### CROSS REFERENCE TO RELATED APPLICATION

This application claims the benefit of Korean Patent Application No. 10-2011-0052812, filed on Jun. 1, 2011, entitled “Driving-Control Module And Method For Inertial Sensor”, which is hereby incorporated by reference in its entirety into this application.

### BACKGROUND OF THE INVENTION

1. Technical Field

The present invention relates to a driving control module and a method for an inertial sensor.

2. Description of the Related Art

Recently, as a small and light inertial sensor is easily manufactured using an MEMS technology, application fields of the inertial sensor is expanded to home appliances including a mobile communication terminal beyond the existing market. Therefore, with the continuous development of functions of the inertial sensor, the function of the inertial sensor is being continuously developed from a uniaxial sensor capable of detecting only an inertial force for a single axis using a single sensor to a multi-axis sensor capable of detecting an inertia force for a multi-axis of two axes or more using a single sensor.

As described above, in order to improve the multi-axis inertial force using a single sensor, that is, a six-axis sensor of three-axis acceleration and three-axis angular velocity, accurate and effective time division driving and control are required.

In the case of the prior art, the sensor cannot accurately determine the time when a driving mass is stably driven, such that driving time and sensing time need to be set in consideration of tolerance or more. In addition, when the driving mass is designed in various sizes and types, the driving time and the sensing time of the sensor cannot be set collectively and control time needs to be set in consideration of tolerance or more, such that productivity may be degraded and the effective driving and the control of sensing cannot be performed.

### SUMMARY OF THE INVENTION

The present invention has been made in an effort to provide a driving control module and a method for an inertial sensor capable of performing an effective control by sensing driving time when a driving mass of a sensor is stabilized, locking application of driving signals from a timing control unit at the time of stabilization driving, and sensing angular velocity that is an inertial force.

According to a preferred embodiment of the present invention, there is provided a driving control module for an inertial sensor, including: a timing control unit that applies a driving signal and a sensing signal; a driving unit that receives the driving signal from the timing control unit and applies the driving signal to a sensor; a sensing unit that receives the sensing signal from the timing control unit, applies the sensing signal to the sensor, and senses stabilization driving and inertial force of the sensor; and a driving control unit that locks application of the driving signal from the timing control unit to the driving unit.

The sensor may include a driving mass, the sensing unit senses the stabilization driving of the driving mass, and the driving control unit locks the application of the driving signal from the timing control unit to the driving unit when the driving mass is stably driven by the sensing unit.

According to another preferred embodiment of the present invention, there is provided a driving control method for an inertial sensor by a driving control module for an inertial sensor, the method including: allowing a timing control unit to apply a driving signal and a sensing signal, respectively, to a driving unit and a sensing unit; allowing the sensing unit to sense whether a driving mass of a sensor is stably driven by the driving unit; allowing the driving control unit to lock application of the driving signal from the timing control unit to the driving unit when the driving mass is stably driven; and allowing the sensing unit to detect the inertial force of the sensor.

The driving control method may further include allowing the driving control unit to permit the application of the driving signal from the timing control unit to the driving unit after the detecting of the inertial force by the sensing unit.

According to another preferred embodiment of the present invention, there is provided a driving control method by the driving control module for an inertial sensor, the method including: allowing a timing control unit to apply a first axis driving signal and a sensing signal, respectively, to a driving unit and a sensing unit; allowing the sensing unit to sense whether a driving mass is stably driven by the driving unit; allowing the driving control unit to lock application of the driving signal from the timing control unit to the driving unit when the driving mass is stably driven; and allowing the sensing unit to detect the first axis inertial force of the sensor; allowing the timing control unit to release the lock of application of the driving signal to the driving unit after allowing the sensing unit to detect the inertial force; and allowing the driving control unit to permit the application of the second axis driving signal from the timing control unit to the driving unit.

The driving control method may further include: allowing the timing control unit to apply the second axis sensing signal to the sensing unit; allowing the sensing unit to sense whether the driving mass is stably driven by the driving unit; allowing the driving control unit to lock the application of the driving signal from the timing control unit to the driving unit when the driving mass is stably driven; and allowing the sensing unit to detect the second axis inertial force of the sensor.

### BRIEF DESCRIPTION OF THE DRAWINGS

FIG. 1 is a configuration diagram schematically showing a driving control module for an inertial sensor according to a preferred embodiment of the present invention.

FIG. 2 is a flow chart schematically showing a driving control method for an inertial sensor according to the preferred embodiment of the present invention.

FIG. 3 is an operational status diagram schematically showing a driving control method for an inertial sensor according to a preferred embodiment of the present invention.

### DESCRIPTION OF THE PREFERRED EMBODIMENTS

Features and advantages of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, a driving control module and a method for an inertial sensor according to preferred embodiments of the present invention will be described with reference to the accompanying drawings.

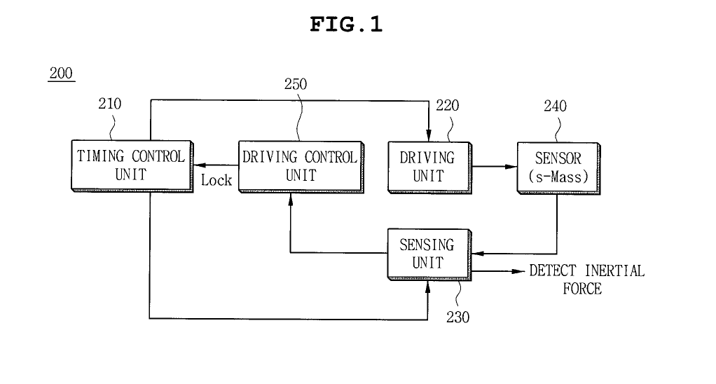

FIG. 1 is a configuration diagram schematically showing a driving control module for an inertial sensor according to an exemplary embodiment of the present invention. As shown in FIG. 1, a driving control module 200 for an inertial sensor includes a timing control unit 210, a driving unit 220, a sensing unit 230, a sensor 240, and a driving control unit 250.

The sensor 240 includes a driving mass and is to detect angular velocity by a time division type. To this end, the timing control unit 210 applies a driving signal and a sensing signal to the driving unit 220 and the sensing unit 230, respectively, according to a time series and the driving unit 220 receives the driving signal from the timing control unit 210 and applies the driving signal to the sensor 240, thereby driving the driving mass.

Further, the sensing unit 230 receives the sensing signal from the timing control unit 210 and applies the sensing signal to the sensor 240, thereby detecting the stabilized driving and inertial force of the driving mass.

In addition, when the stabilized driving of the driving mass is sensed in the sensing unit 230 at the time of the driving of the sensor by the driving unit, the driving control unit 250 receives the signal therefor from the sensing unit to control the timing control unit 210 to apply the driving signal to the driving unit. Further, the driving control unit 250 may be performed by an automatic gain control (AGC).

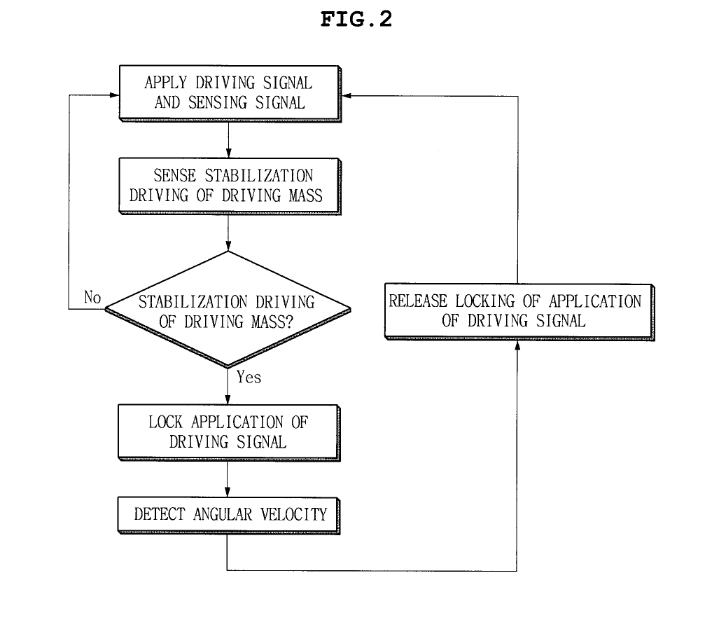

FIG. 2 is a flow chart schematically showing the driving control method for an inertial sensor according to the exemplary embodiment of the present invention. As shown in FIG. 2, the driving control method for an inertial sensor is implemented using the driving control module for an inertial sensor shown in FIG. 1. In more detail, the timing control unit applies the driving signal and the sensing signal to the driving unit and the sensing unit, respectively, the sensing unit senses whether the driving mass of the sensor is stably driven by the driving unit, the timing control unit continuously applies the driving signal when the driving mass is not stably driven, and the driving control unit locks the application of the driving signal from the timing control unit to the driving unit when the driving mass is stably driven. Further, the sensing unit detects angular velocity.

Further, after the angular velocity is detected for predetermined time, the driving control unit permits a release of the locking of the application of the driving signal from the timing control unit to the driving unit, that is, to apply the driving signal.

In addition, the driving control method for an inertial sensor according to the exemplary embodiment of the present invention senses the angular velocity by alternating the sensing and the driving in two axes.

To this end, the timing control unit applies a first axis driving signal and the sensing signal to the driving unit and the sensing unit, respectively, the sensing unit senses whether the driving mass is stably driven by the driving unit, the driving control unit locks the application of the driving signal from the timing control unit to the driving unit when the driving mass is stably driven, and the sensing unit detects the angular velocity.

Further, after the angular velocity is detected for the predetermined time, the timing control unit releases the locking of application of the driving signal to the driving unit and the driving control unit permits the timing control unit to apply a second-axis driving signal to the driving unit.

Further, the timing control unit applies the second-axis sensing signal to the sensing unit and the sensing unit senses whether the driving mass is stably driven by the driving unit.

When the driving mass is stably driven, the driving control unit locks the application of the driving signal from the timing control unit to the driving unit. Further, the sensing unit detects the second-axis inertial force of the sensor.

The driving control method for an inertial sensor according to the exemplary embodiment of the present invention is performed as described above and thus, senses the angular velocity by alternating the sensing and the driving in two axes.

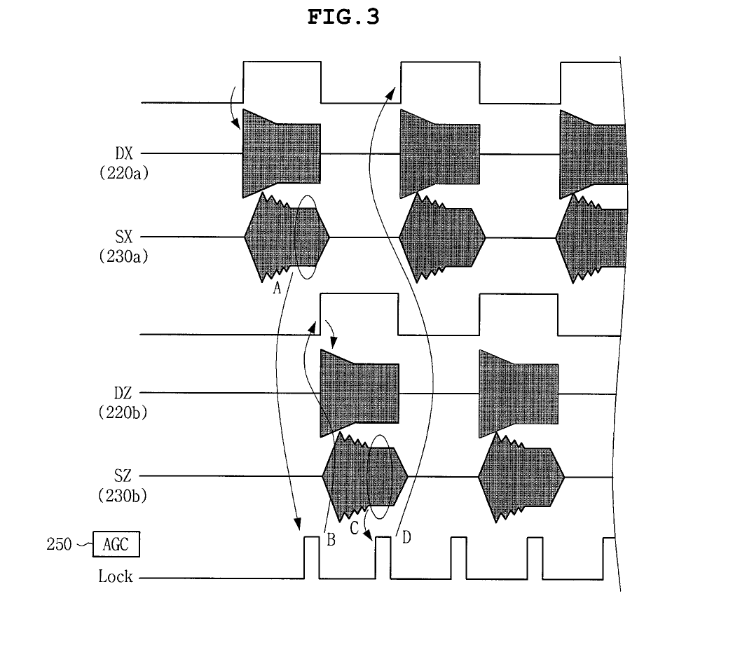

FIG. 3 is an operational status diagram schematically showing the driving control method for an inertial sensor according to the exemplary embodiment of the present invention and shows the control of the application of the driving and sensing signal according to the time division type so as to sense the angular velocity in X-axis and Z-axis directions for the driving control method for a multi-axis inertial sensor.

As shown in FIG. 3, the timing control unit (not shown) applies an X-axis driving signal to an X-axis directional driving electrode 220a that is the driving unit and applies the sensing signal to an X-axis directional sensing electrode 230a that is the sensing unit. In addition, the timing control unit applies the driving signal larger than the reference signal so as to have a rapid response at an early stage. Further, the reference signal is an average signal that is the stabilized driving signal of the driving mass by the repeated test, which may be easily understood by those skilled in the art. Next, the sensing electrode 230a that is the sensing unit senses the time when the driving of the driving mass by the driving electrode 220a is stabilized and the AGC 250 that is the driving control unit locks the application of the driving signal from the timing control unit to the driving unit at point A sensing when the driving mass is stably driven. Further, the sensing electrode 230a detects the angular velocity that is the inertial force for the predetermined time.

Further, the timing control unit is permitted to again apply the Z-axis driving signal to a Z-axis directional driving electrode 220b that is the driving unit by the AGC 250 at point B where the angular velocity sensing completes. The sensing signal is applied to the Z-axis directional sensing electrode 230b that is the sensing unit.

Even in this case, the timing control unit applies the signal larger than the reference signal so as to have a rapid response at an early stage. Further, the Z-axis directional sensing electrode 230b senses the driving time when the driving of the driving mass is stabilized by the driving electrode 220b and the AGC 250 locks the application of the driving signal from the timing control unit to the driving unit at point C sensing when the driving mass is stably driven. Further, the sensing electrode 230b senses the angular velocity for the predetermined time and the AGC 250 permits the application of the X-axis driving signal from the timing control unit to the driving unit at point D where the angular sensing is completed.

As described above, the exemplary embodiment of the present invention can reduce the time loss and obtain the maximum sampling rate by sensing the time when the driving mass of the sensor is stably driven at the time of alternating the driving and the sensing in the X-axis and Z-axis directions and the inertial force for the predetermined time even though the multi-axis inertial sensor is implemented and can perform the customized driving and sensing by the automatic control even though the size of the driving mass and the design of the sensor are changed.

As set forth above, the preferred embodiment of the present invention can obtain the driving control module and the method for the inertial sensor capable of obtaining the maximum sampling rate by sensing the driving time when the driving mass of the sensor is stabilized, locking the application of driving signal from the timing control unit at the time of stabilization driving, and sensing the angular velocity that is the inertial force and performing the effective control by reducing the additional driving for stabilized sensing and time loss of sensing.

Although the embodiments of the present invention has been disclosed for illustrative purposes, it will be appreciated that a driving control module and a method for an inertial sensor according to the present invention are not limited thereby, and those skilled in the art will appreciate that various modifications, additions and substitutions are possible, without departing from the scope and spirit of the invention.

Such modifications, additions and substitutions should also be understood to fall within the scope of the present invention.

What is claimed is:

1. A driving control module for an inertial sensor, comprising:
a timing control unit that applies a driving signal and a sensing signal;
a driving unit that receives the driving signal from the timing control unit and applies the driving signal to a sensor;
a sensing unit that receives the sensing signal from the timing control unit, applies the sensing signal to the sensor, and senses stabilization driving and inertial force of the sensor; and
a driving control unit that locks application of the driving signal from the timing control unit to the driving unit.

2. The driving control module as set forth in claim 1, wherein the sensor includes a driving mass, the sensing unit senses the stabilization driving of the driving mass, and the driving control unit locks the application of the driving signal from the timing control unit to the driving unit when the driving mass is stably driven by the sensing unit.

3. The driving control module as set forth in claim 1, wherein the driving control unit is an auto gain control (AGC).

4. A driving control method for an inertial sensor by a driving control module for an inertial sensor as set forth in claim 1, the method comprising:
allowing a timing control unit to apply a driving signal and a sensing signal, respectively, to a driving unit and a sensing unit;
allowing the sensing unit to sense whether a driving mass of a sensor is stably driven by the driving unit;
allowing the driving control unit to lock application of the driving signal from the timing control unit to the driving unit when the driving mass is stably driven; and
allowing the sensing unit to detect the inertial force of the sensor.

5. The method as set forth in claim 4, further comprising allowing the driving control unit to permit the application of the driving signal from the timing control unit to the driving unit after the detecting of the inertial force by the sensing unit.

6. A driving control method by the driving control module for an inertial sensor as set forth in claim 1, the method comprising:
allowing a timing control unit to apply a first axis driving signal and a sensing signal, respectively, to a driving unit and a sensing unit;
allowing the sensing unit to sense whether a driving mass is stably driven by the driving unit;
allowing the driving control unit to lock application of the driving signal from the timing control unit to the driving unit when the driving mass is stably driven;
allowing the sensing unit to detect the first axis inertial force of the sensor;
allowing the timing control unit to release the lock of application of the driving signal to the driving unit after allowing the sensing unit to detect the inertial force; and
allowing the driving control unit to permit the application of the second axis driving signal from the timing control unit to the driving unit.

7. The method as set forth in claim 6, further comprising:
allowing the timing control unit to apply the second axis sensing signal to the sensing unit;
allowing the sensing unit to sense whether the driving mass is stably driven by the driving unit;
allowing the driving control unit to lock the application of the driving signal from the timing control unit to the driving unit when the driving mass is stably driven; and
allowing the sensing unit to detect the second axis inertial force of the sensor.
